(19) United States
(12) Patent Application Publication
(10) Pub. No.: US 2023/0394524 A1
(43) Pub. Date: Dec. 7, 2023

(54) OPTIMIZING REAL-TIME BIDDING USING CONVERSION TRACKING TO PROVIDE DYNAMIC ADVERTISEMENT PAYLOADS

(71) Applicant: Catalina Marketing Corporation, St. Petersburg, FL (US)

(72) Inventors: Zubin Singh, St. Petersburg, FL (US); Thierry Roullier, Chicago, IL (US); Adam Peter Frank Drini, Roswell, GA (US); Talia Strait, Chicago, IL (US); Xin Ma, Atlanta, GA (US)

(21) Appl. No.: 18/032,070

(22) PCT Filed: Oct. 15, 2021
(86) PCT No.: PCT/US2021/055270

§ 371 Date: Apr. 14, 2023

Related U.S. Application Data
(60) Provisional application No. 63/093,074, filed on Oct. 16, 2020.

(51) Int. Cl. G06Q 30/0242; G06Q 30/0251

(52) U.S. Cl. CPC G06Q 30/0246; G06Q 30/0268

(57) ABSTRACT

A method including receiving data including an impression value and an attribution value for a list item in an advertising campaign is provided. The method includes correlating the data with multiple advertising attributes of the advertising campaign to identify a salient attribute for an expected result of the advertising campaign. The method also includes modifying the salient attribute in an advertisement payload for the list item and providing the advertisement payload including the salient attribute to a server in a network for distribution among users communicatively coupled to the network. A system and a non-transitory, computer-readable medium storing instructions to cause the system to perform the above method are also provided.

### CROSS-REFERENCE TO RELATED APPLICATIONS

The present disclosure is related to and claims priority under the PCT to U.S. Prov. Appln. No. 63/093,074, entitled “OPTIMIZING REAL-TIME BIDDING USING CONVERSION TRACKING TO PROVIDE DYNAMIC ADVERTISEMENT PAYLOADS,” to Singh, et-al. filed on Oct. 16, 2020, the contents of which are hereby incorporated by reference in their entirety, for all purposes.

### BACKGROUND

### Field

The present disclosure is related to advertisement technologies to improve advertisement campaigns. More specifically, the present disclosure is directed to methods and systems to provide dynamic advertisement payloads optimized to improve the performance of an advertising campaign.

### Brief Background Description

Current advertising campaign techniques offer static approaches where the performance of an advertising campaign is evaluated in its multiple measurement attributes a posteriori, typically after considerable funds have been invested in a long-lasting campaign.

### BRIEF DESCRIPTION OF THE DRAWINGS

FIG. 1 illustrates an example architecture suitable for presenting personalized digital promotions to a consumer, according to some embodiments.

FIG. 2 is a block diagram illustrating an example server and client from the architecture of FIG. 1, according to certain aspects of the disclosure.

FIG. 3 illustrates components in a system for optimizing digital advertising campaigns, according to some embodiments.

FIGS. 4A-4E illustrate screenshots obtained in a graphic user interface accessing a system for optimizing digital advertising, according to some embodiments.

FIG. 5 illustrates an advertisement payload provided by an ad creative engine, according to some embodiments.

FIGS. 6A-6B illustrate charts displayed in a graphic user interface accessing a system for optimizing digital advertising, according to some embodiments.

FIG. 7 is a flow chart illustrating steps in a method for enabling digital advertising identifier consent conversion for tracking across different applications, according to some embodiments.

FIG. 8 is a flow chart illustrating steps in a method for providing a personalized advertising payload to a client device, according to some embodiments.

FIG. 9 is a block diagram illustrating an example computer system with which the client and server of FIGS. 1 and 2 and the methods of FIGS. 7 and 8 can be implemented.

In the figures, elements and steps denoted by the same or similar reference numerals are associated with the same or similar elements and steps, unless indicated otherwise.

### SUMMARY

In a first embodiment, a computer-implemented method includes receiving data including an impression value and an attribution value for a list item in an advertising campaign and correlating the data with multiple advertising attributes of the advertising campaign to identify a salient attribute for an expected result of the advertising campaign. The computer-implemented method also includes modifying the salient attribute in an advertisement payload for the list item and providing the advertisement payload including the salient attribute to a server in a network for distribution among users communicatively coupled to the network.

In a second embodiment, a computer-implemented method, includes receiving, in a server, an advertisement payload from a campaign server, the advertisement payload including a salient attribute, for distribution among users communicatively coupled to the server. The computer-implemented method also includes identifying a channel for transmission of the advertisement payload, selecting at least one user based on the salient attribute, and retrieving an identification for a client device associated to the at least one user based on the channel for transmission. The computer-implemented method also includes providing the advertisement payload to the client device via the channel for transmission.

In a third embodiment, a system includes one or more processors and a memory storing instructions which, when executed by the processors, cause the system to perform operations including: to receive data including an impression value and an attribution value for a list item in an advertising campaign, to correlate the data with multiple advertising attributes of the advertising campaign to identify a salient attribute for an expected result of the advertising campaign, to modify the salient attribute in an advertisement payload for the list item, and to provide the advertisement payload including the salient attribute to a server in a network for distribution among users communicatively coupled to the network.

In yet other embodiment, a system includes a first means to execute instructions, and a second means to execute the instructions, to cause the system to perform a method, including receiving data including an impression value and an attribution value for a list item in an advertising campaign and correlating the data with multiple advertising attributes of the advertising campaign to identify a salient attribute for an expected result of the advertising campaign. The method also includes modifying the salient attribute in an advertisement payload for the list item, and providing the advertisement payload including the salient attribute to a server in a network for distribution among users communicatively coupled to the network.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

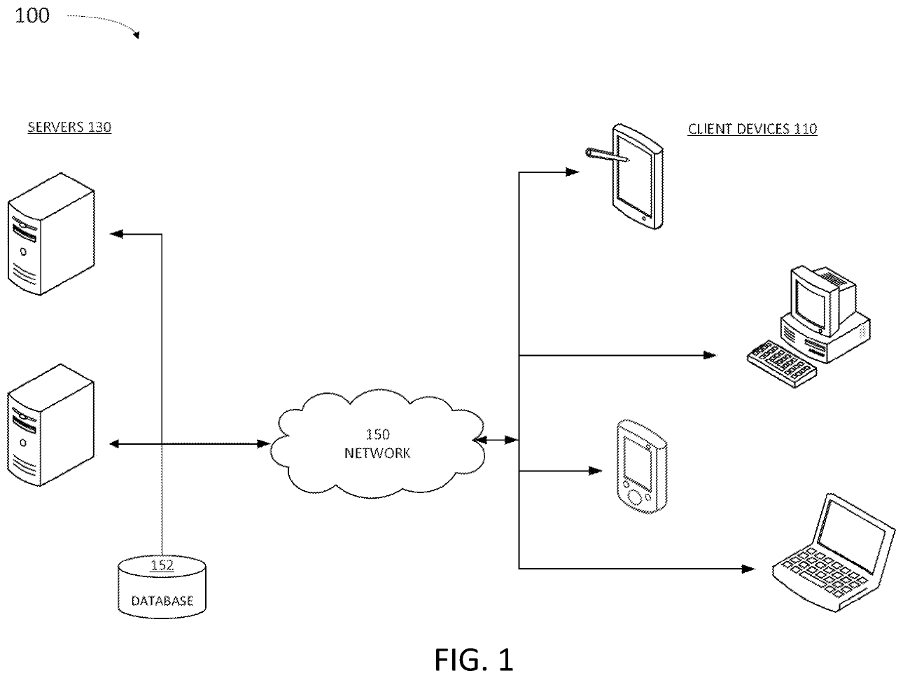

FIG. 1 illustrates an example architecture 100 for a multi-touch attribution engine suitable for practicing some implementations of the disclosure. Architecture 100 includes servers 130 and client devices 110 coupled over a network 150. One of the many servers 130 is configured to host a memory, including instructions which, when executed by a processor, cause the server 130 to perform at least some of the steps in methods as disclosed herein. In some embodiments, architecture 100 is configured to provide an advertisement payload to a consumer, who may be the user of client device 110. The advertisement payload may include a targeted digital promotion collected from a purchase history of the consumer, which may be stored in a history log in a memory of the server or in a database 152.

Servers 130 may include any device having an appropriate processor, memory, and communications capability for hosting the history log, a digital promotion database, an advertising technology server, a dynamic optimization engine, and a multi-touch attribution engine. The multi-touch attribution engine may be accessible by one or more client devices 110 over the network 150. In some embodiments, servers 130 may include a dynamic creative rendering server, a publisher, or supply side platform (SSP) server, and a demand side platform (DSP) server. Client devices 110 may include, for example, desktop computers, mobile computers, tablet computers (e.g., including e-book readers), mobile devices (e.g., a smartphone or PDA), or any other devices having appropriate processor, memory, and communications capabilities for accessing multi-touch attribution engine and the history log on one or more of servers 130. Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

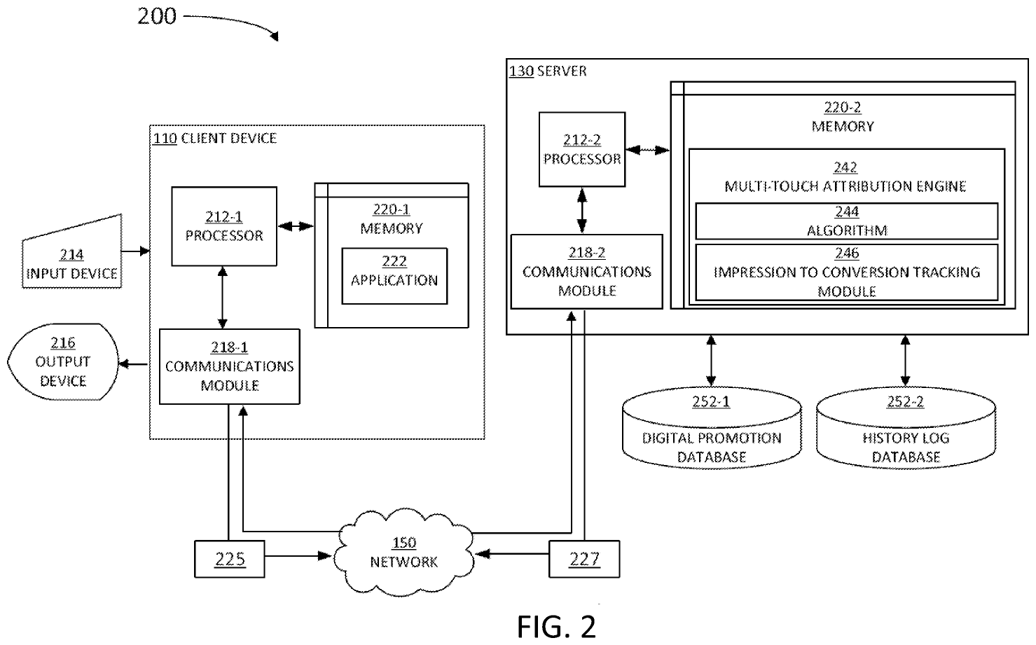

FIG. 2 is a block diagram 200 illustrating an example server 130 and client device 110 in the architecture 100 of FIG. 1, according to certain aspects of the disclosure. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as data, requests, responses, and commands to other devices on the network. Communications modules 218 can be, for example, modems or Ethernet cards. Client device 110 may be coupled with an input device 214 and with an output device 216. Input device 214 may include a keyboard, a mouse, a pointer, or even a touch-screen display that a consumer may use to interact with client device 110. Likewise, output device 216 may include a display and a speaker with which the consumer may retrieve results from client device 110. Client device 110 may also include a processor 212-1, configured to execute instructions stored in a memory 220-1, and to cause client device 110 to perform at least some of the steps in methods consistent with the present disclosure. Memory 220-1 may further include an application. Application 222 includes specific instructions which, when executed by processor 212-1, cause a digital promotion payload 227 from server 130 to be displayed for the consumer. Digital promotion payload 227 may include multiple digital promotions or coupons presented to the consumer by server 130, and the consumer may store at least some of the digital promotions or coupons from digital promotion payload 227 in memory 220-1.

In some embodiments, applications 222 may include a mobile wallet application, configured to store a value offer (e.g., a coupon, a discount, and the like), which has been selected (e.g., “clipped”) by the consumer from any one of the multiple digital promotions or coupons in digital promotion payload 227. Further, in some embodiments, a mobile wallet application may associate the value offer selected by the consumer to a frequent shopper ID (FSC-ID) for a retailer. Applications 222 may be installed in memory 220-1 by the manufacturer, together with the installation of an operating system that controls all hardware operations of client device 110. Moreover, in some embodiments, a consumer may download a retailer application in client device 110 for the retailer. The consumer may have an FSC-ID associated with application 222. In some embodiments, in addition to one or more “brick and mortar” physical locations of stores for the retailer, the retailer may host an online shopping outlet hosted by a network server (e.g., server 130).

Server 130 includes a memory 220-2, a processor 212-2, and a communications module 218-2. Processor 212-2 is configured to execute instructions, such as instructions physically coded into processor 212-2, instructions received from software in memory 220-2, or a combination of both. Memory 220-2 includes a multi-touch attribution engine 242, configured to identify and correlate a consumer to a purchase event and an advertisement “touch” event. When the user authorizes tracking of transactions for application 222, multi-touch attribution engine 242 may direct a server 130 associated with advertising or with a retailer to prepare digital promotion payload 227. Accordingly, server 130 may be configured to integrating images, videos, and other multimedia files from a digital promotion database 252-1 into a digital promotion payload 227. Transaction tracking engine 242 may push digital promotions from digital promotion database 252-1 to a consumer of client device 110 that is a consumer of a retailer store or chain of stores through application 222 or a web browser installed in client device 110. Accordingly, application 222 may be installed by server 130 and perform scripts and other routines provided by server 130. In some embodiments, at least one of application 222 may be configured to display digital promotion payload 227 provided by an ad creative server. In some embodiments, client device 110 may provide data 225 to server 130. Data 225 may include a client device identifier 225, or a user identifier in a network hosted by server 130.

Digital promotion payload 227 is integrated based on information retrieved from a digital promotion database 252-1 and a history log database 252-2 (hereinafter, collectively referred to as “databases 252”). History log database 252-2 includes the purchase history of multiple consumers listed in digital promotion database 252-1. To achieve this, in some embodiments, an algorithm 244 stores commands which, when executed by processor 212-2, causes server 130 to integrate digital promotion payload 227. Algorithm 244 may include a neural network (NN) trained over databases 252, to select digital promotion payload 227 targeted to the specific preferences of a consumer when the consumer grants application 222 to track user transactions. In some embodiments, an SSP server hosting the network site accessed through application 222 may be different from a DSP server hosting transaction tracking engine 242.

In one or more implementations, digital promotion database 252-1 integrates digital promotion payloads including coupons and digital promotions for multiple products on sale by a retailer having one or more stores. Digital promotion database 252-1 may include a list of frequent consumers of a retailer. The retailer may create, update, and maintain databases 252. In that regard, databases 252 may be hosted by a DSP server or a dynamic creative rendering server. Accordingly, the DSP server may have access to one or more databases 252 through business agreements with one or more retailers.

In certain aspects, processor 212-2 in a server 130 is configured to determine data for history log database 252-2 by obtaining consumer purchasing data identifying the consumer via the frequent shopper identification used at multiple purchasing events in multiple locations, over a pre-selected span of time. In some embodiments, history log database 252-2 includes online purchasing history for the consumer through applications 222 or a network browser. Processors 212-1 and 212-2 will be collectively referred, hereinafter, as “processors 212.” Memories 220-1 and 220-2 will be collectively referred, hereinafter, as “memories 220.”

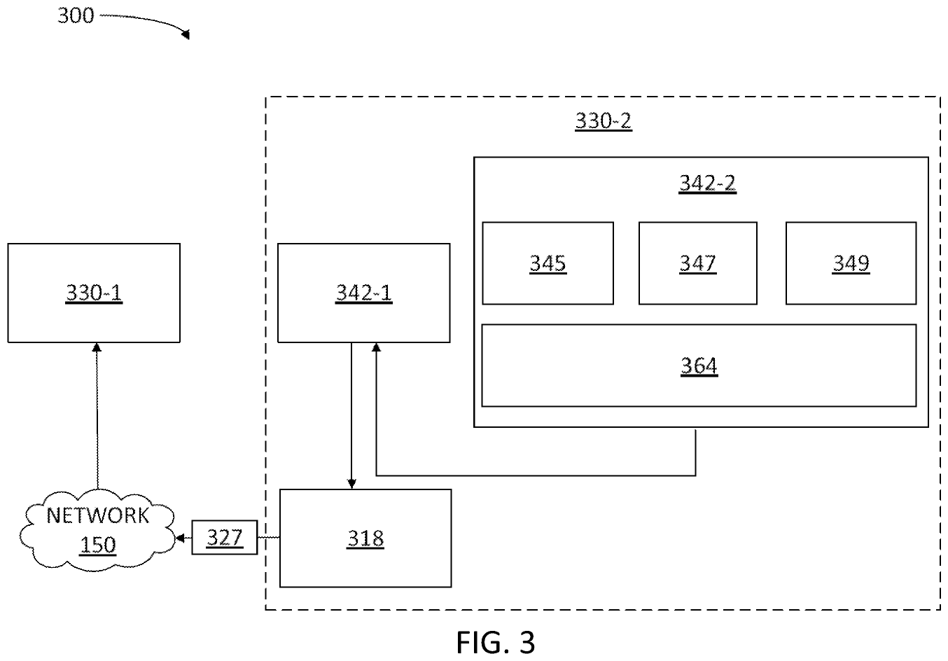

FIG. 3 is a block diagram illustrating some of the components in a system 300 configured for optimizing digital advertising campaigns, as disclosed herein. An advertising technology server 330-1 is communicatively coupled with one or more servers 330-2 in a system to optimize digital advertising campaigns via a network. The system to optimize digital advertising campaigns includes a dynamic optimization engine 342-1, a multi-touch attribution (MTA) engine 342-2, and an application layer interface 318. MTA engine 342-2 includes a channel/device module 345 to select whether a particular advertisement is provided via a mobile application or via a browser to a desktop device, and an ad creative module 347 to provide an advertisement payload 327, and further attribution and other insights modules 349. The advertisement payload may include attributes such as advertising channel and format. The advertisement channel indicates the medium selected by the channel/device module for advertisement payload 327 to reach the consumer, e.g., mobile device, mobile application, mobile web, desktop application, and the like. The format may indicate a display size for the advertisement, and other features such as scroll images, gif application, or short video.

An impression exposure to conversion tracking module 364 taps into MTA engine 342-2 to feed an advertisement payload and associated insights and attributes to dynamic optimization engine 342-1. For example, impression exposure to conversion tracking module 364 tracks impression exposures to in-store purchase conversions (e.g., events when a consumer who had access to an advertisement payload for an item purchased at a store, thereafter).

Dynamic optimization engine 342-1 takes the conversion data from MTA engine 342-2 and algorithmically determines an optimization edit to the digital ad campaign based on channel performance, ad creative performance, and other data elements and advertising campaign attributes from MTA engine 342-2. Accordingly, system 300 provides an optimized advertisement payload to advertising technology server 330-1 via application layer interface 318. Advertisement payload 327 is generated by ad creative module 347 that forms the payload from a design including images of an item or service, which is the subject of the advertising campaign. Advertisement payload 327 features the item for advertisement. The advertisement payload may include an image, or a group of images for scrolling, or forming a short video or gif file. The item for advertisement may include a consumer packaged good (CPG), or a service, or any other item of manufacture, branded or generic.

More generally, system 300 is configured to design and optimize an advertising campaign for a client. The client may be a CPG brand manufacturer, a retail store chain, or a service provider. The advertising campaign may include several attributes, such as a list of one or more products that are being promoted, e.g., identified by a unique product code (UPC), a location where the campaign will be deployed, and a temporal extent of the campaign. Each of these attributes may be determined by multiple environmental factors, such as seasoning, and other circumstantial conditions such as weather events, social events—e.g., sports tournaments, conventions-, and the like.

For each of the items that are the subject of the advertising campaign, one or more advertisement payloads may be generated by the ad creative module. Advertising technology server 330-1 provides advertisement payload 327 to the consumer via the selected channel 345, typically embedded in a mobile application or browser (cf. application 222). In some embodiments, advertisement payload 327 includes a pixel that triggers a signal once advertisement payload 327 runs in the consumer device. The signal is transmitted from advertising technology server 330-1 to system 300 and is counted as an “impression.” When the consumer purchases the item for advertisement, an attribution count for advertisement payload 327 increases by one (1) in system 300. In some embodiments, system 300 is able to correlate a purchasing event of the item for advertisement with the impression from the pixel signal, which indicates that the consumer accessed advertisement payload 327 from advertising technology server 330-1. To do this, in some embodiments, system 300 may request permission from the consumers for tracking purchasing information via an identification code, such as a mobile device identifier, a frequent shopper ID, an ID for advertisement (IDFA), or a combination of such ID values.

Dynamic optimization engine 342-1 stores historical data from MTA engine 342-2, and includes an algorithm that predicts a performance based on the attributes of the advertising campaign and the historical data. Moreover, dynamic optimization engine 342-1 may modify some of the attributes to improve the performance of the advertising campaign. For example, dynamic optimization engine 342-1 may be configured to identify an advertisement channel 345 that provides a better impression value or a better attribution value for the advertising campaign. Accordingly, dynamic optimization engine 342-1 may increase or enhance the amount and value of advertising resources devoted to this channel. In some embodiments, dynamic optimization engine 342-21 may identify a neighborhood, a zip code, a city, or a region, where the advertisement campaigns obtains better impression values and attribution conversion values.

In some embodiments, dynamic optimization engine 342-1 may modify attributes in advertisement payload 327, such as the creative content. For example, dynamic optimization engine 342-1 may change the format, the size, and the graphic elements in advertisement payload 327. In some embodiments, dynamic optimization engine 342-1 may modify attributes such as color, theme, shades, and gradation within advertisement payload 327. In some embodiments, dynamic optimization engine 342-1 may adjust or modify the text and content of advertisement payload 327. In that regard, dynamic optimization engine 342-1 may be configured to perform a semantic analysis of textual content in the advertisement payload. Having access to a history log of prior advertising campaigns and access to data of a current advertising campaign, dynamic optimization engine 342-1 may correlate the graphics and textual attributes of advertisement payload 327 with one or more of the metrics in the advertisement campaign (e.g., impression values and attribution values).

Dynamic optimization engine 342-1 may be configured to periodically collect impression data or attribution data from the advertising campaign, to modify advertisement payload 327. For example, in some embodiments, dynamic optimization engine 342-1 may collect advertising data on a daily basis, or weekly basis, and modify advertisement payload 327 on the same basis.

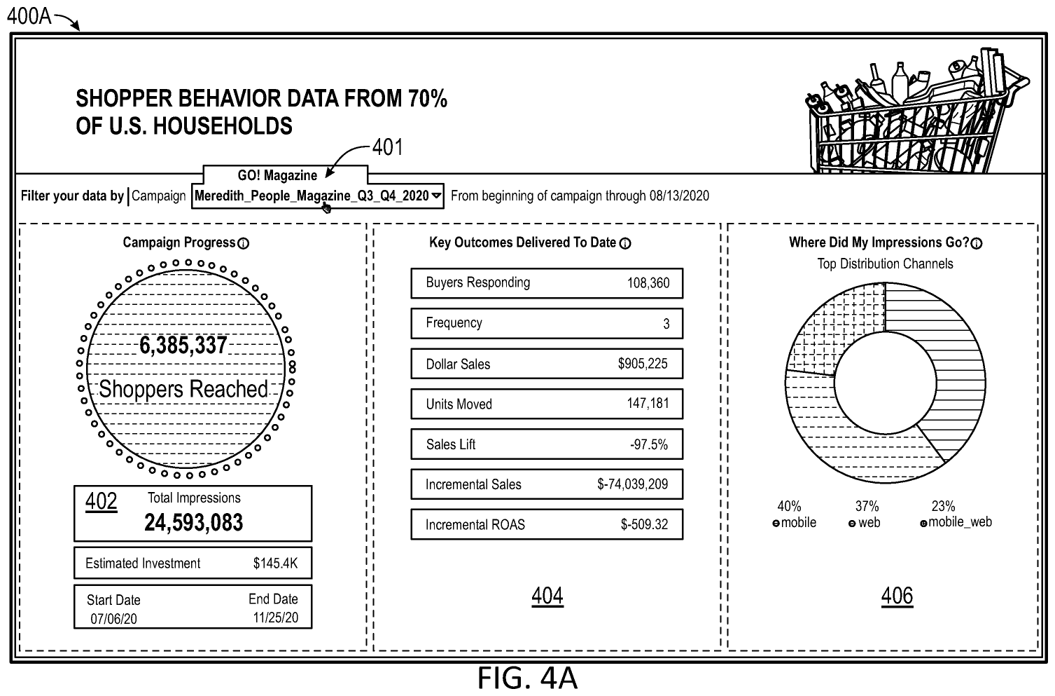

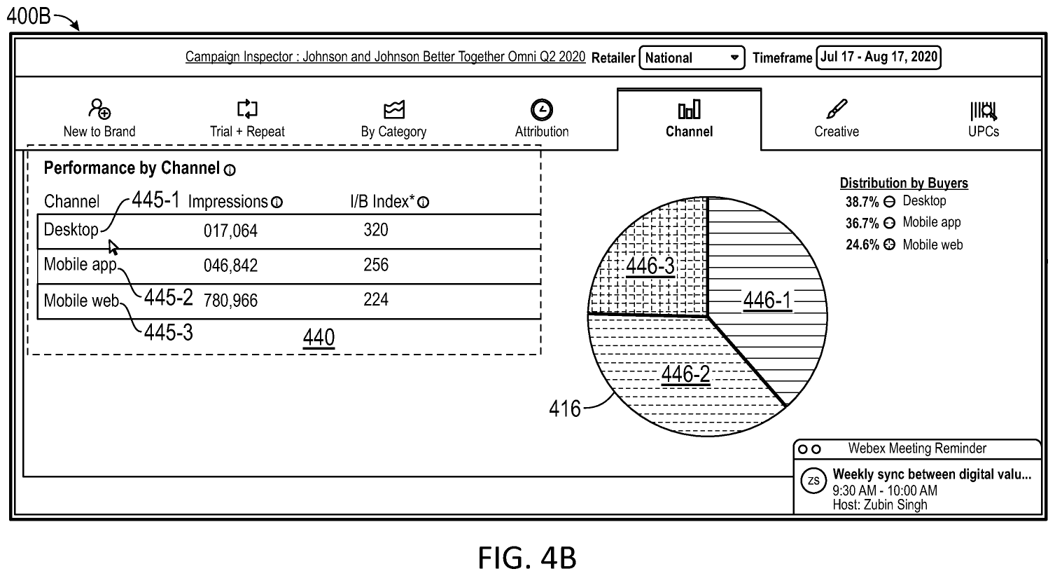

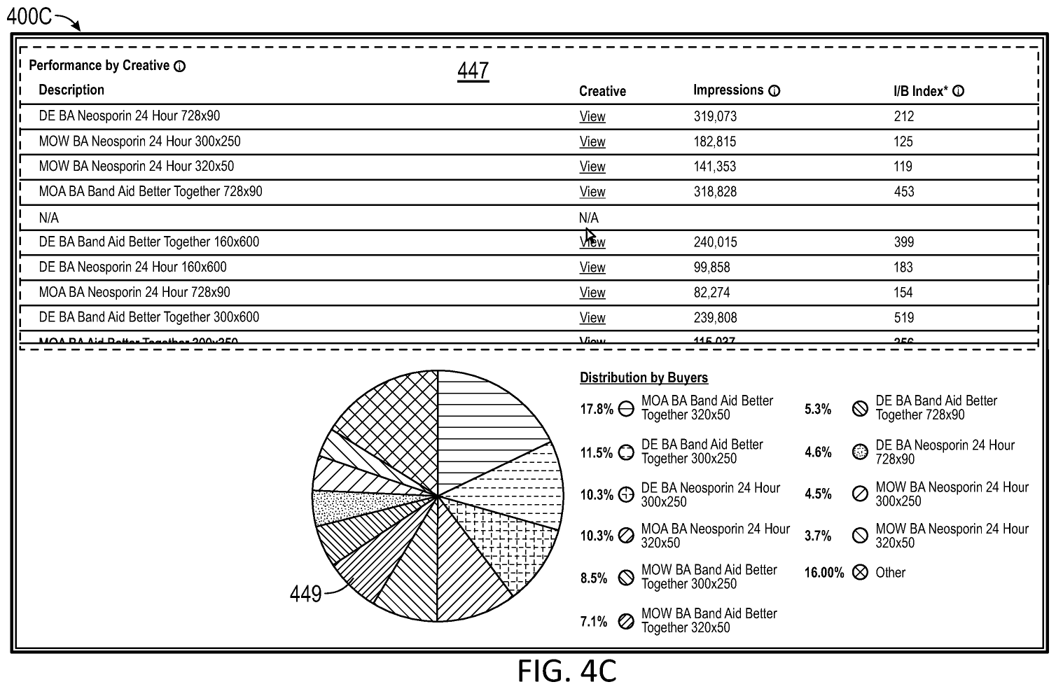

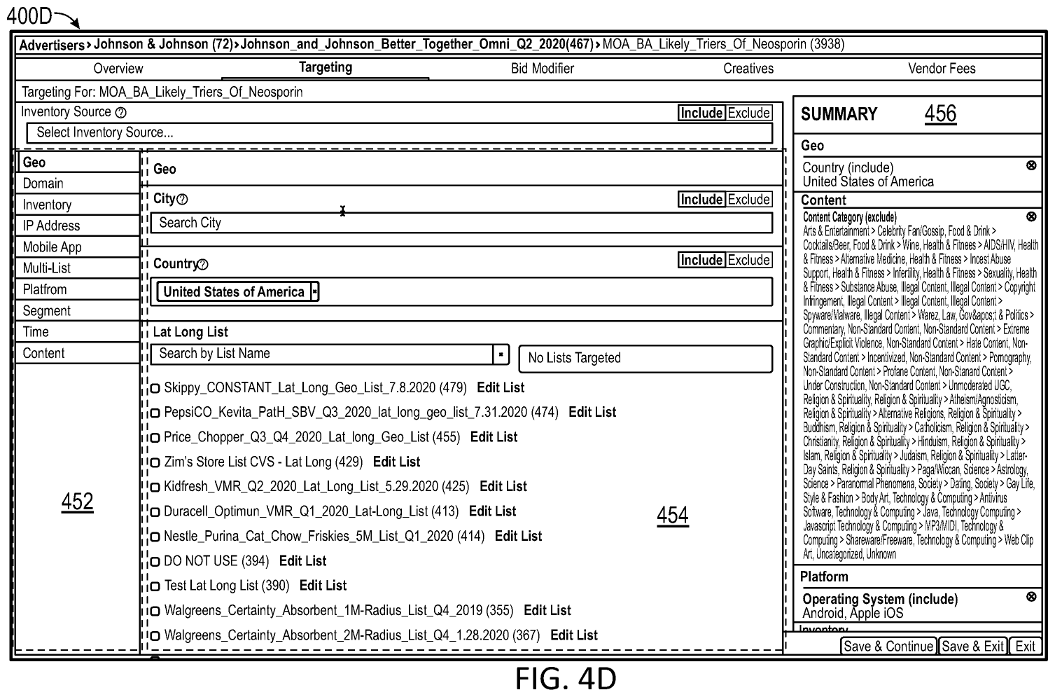

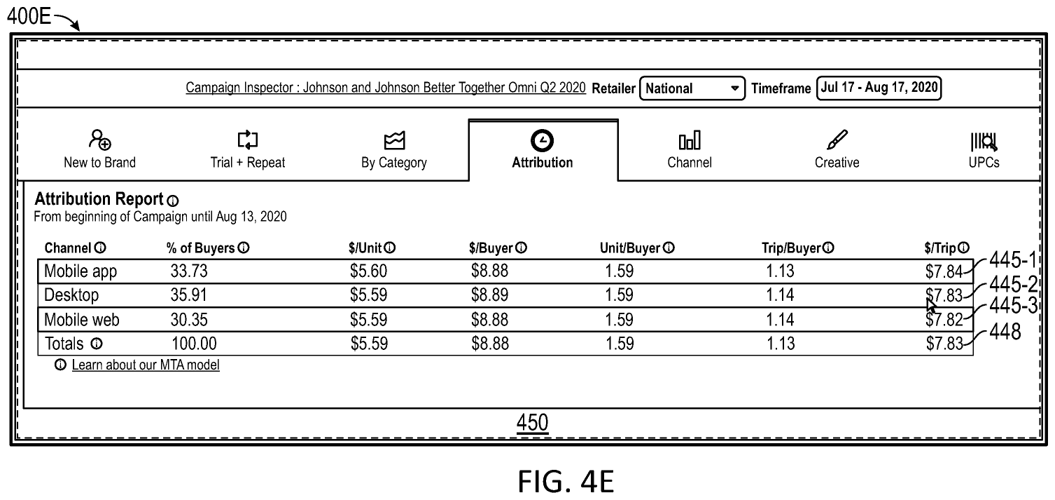

FIGS. 4A-4E illustrate screenshots 400A, 400B, 400C, 400D, and 400E (hereinafter, collectively referred to as “screenshots 400”), obtained in a graphic user interface accessing a system for optimizing digital advertising (cf. system 300), according to some embodiments. A user of the system for optimizing digital advertising may select a specific advertising campaign 401.

FIG. 4A illustrates screenshot 400A for shopper behavior data from a given percentage of US households, in relation to advertising campaign 401. A panel 402 illustrates a total universe of consumers reached by advertising campaign 401. A panel 404 illustrates key outcomes of the campaign, e.g., buyers responding, frequency, dollar sales, units moved—sold—sales lift, incremental sales, incremental return on advertisement—ROA. The sales lift is a measure of the change in sales of a given product effected by ad campaign 401. A panel 406 indicates in a donut chart the relative proportion of different channels used in ad campaign 401.

FIG. 4B illustrates screen shot 400B identifying in a panel 440 the different channels 445-1 (desktop), 445-2 (mobile application, e.g., application 222), and 445-3 (mobile web). Hereinafter, channels 445-1, 445-2, and 445-3 will be collectively referred to as “channels 445”) used in ad campaign 401. A pie chart 416 illustrates the data in panel 440 for channels 445 according to slices 446-1, 446-2, and 446-3 (hereinafter, collectively referred to as “slices 446”), respectively.

FIG. 4C illustrates screenshot 400C including a panel 447 identifying multiple ad creatives for one or more products in a campaign, and their respective performance in terms of impressions (the ad creative being viewed by a consumer) and impressions to buy index (ratio of impressions to purchases). Screenshot 400C also includes a pie chart 449 of the different ad creatives in panel 447 based on a distribution of buyers (the percentage of product buyers that watched a specific ad creative).

FIG. 4D illustrates screen shot 400D for editing an advertising campaign (which may include multiple ad creatives directed through multiple channels). Panel 452 includes campaign attributes for user selection. Panel 454 includes an editing menu for the campaign attribute selected from panel 452. Panel 456 includes a summary of the campaign attribute script as edited by the user.

FIG. 4E illustrates screen shot 400E with a panel 450 including an attribution report including totals 448 for channels 445. Panel 450 may include detailed values such as the number of trips that a given buyer made to a store until it finally purchased the advertised product.

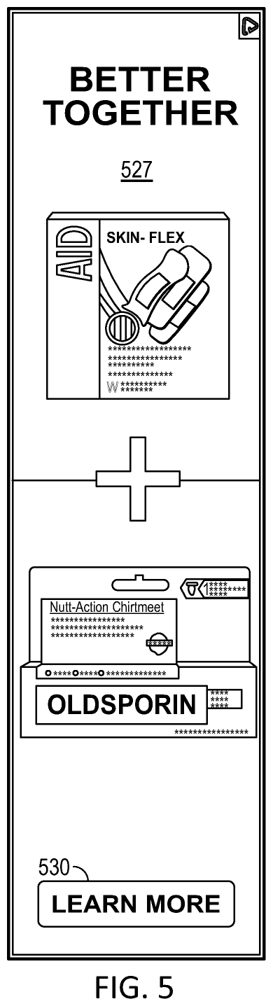

FIG. 5 illustrates an advertisement payload 527 provided by an ad creative engine in an advertising technology server (cf. advertising technology server 330-1), according to some embodiments. As seen, payload 527 may include one or more products. Payload 527 may be received and displayed in a GUI of a mobile device with the consumer by an application installed therein (e.g., client devices 110, and application 222). In some embodiments, payload 527 includes actionable buttons and tabs, such as button 530. Accordingly, when a consumer activates button 530, the application may open a website with more information about the products, a retailer carrying the products, or the brand (depending on business rules established by the advertising technology server), through a browser, or may actually call a second mobile application in the client device, associated with the product manufacturer, the retailer, or the advertising technology server.

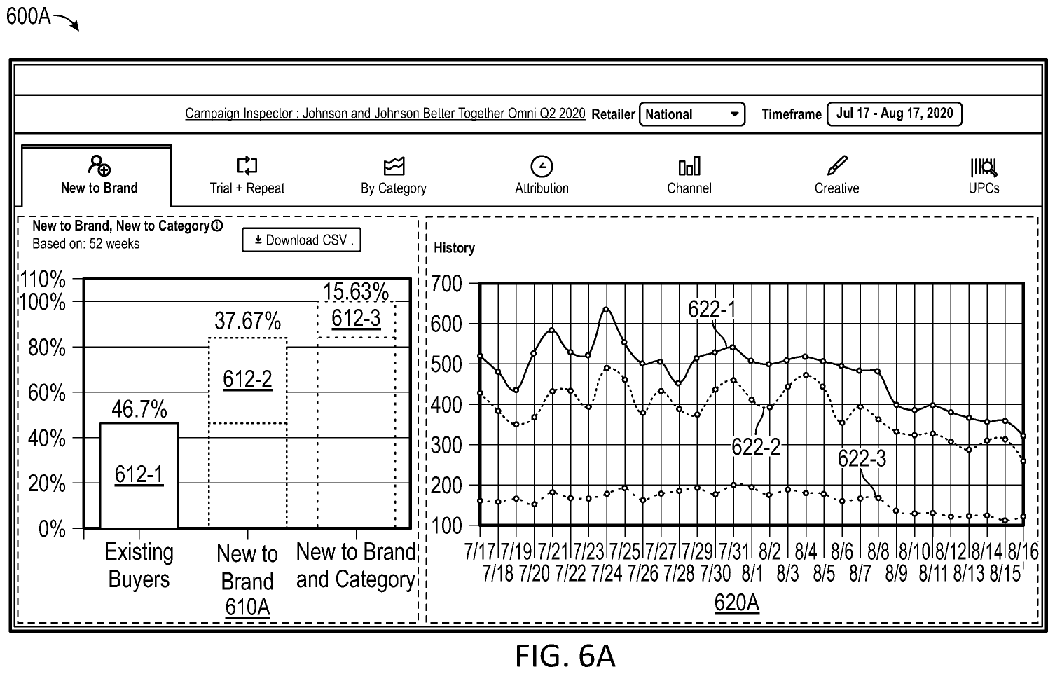

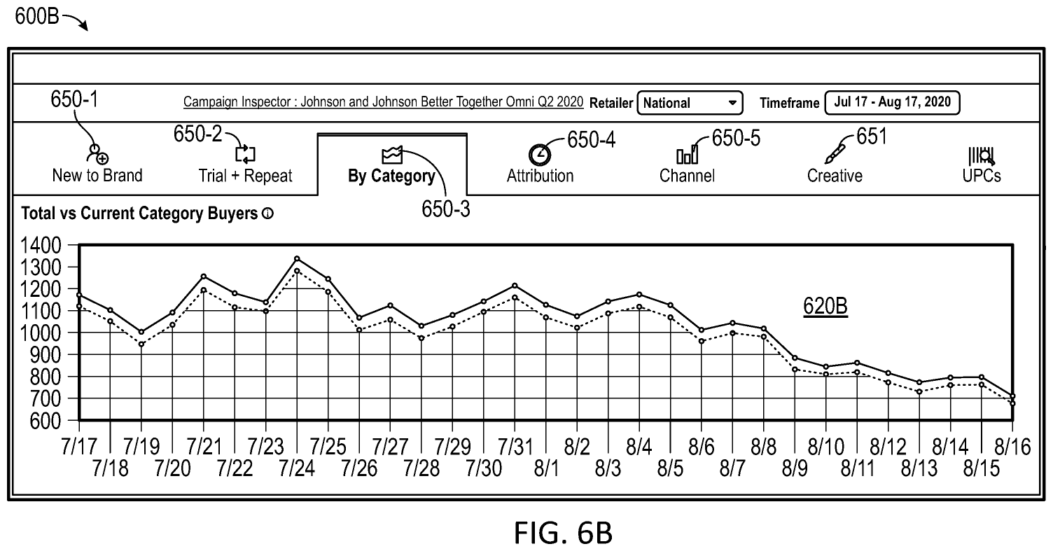

FIGS. 6A-6B illustrate screenshots 600A and 600B including charts 620A and 620B (hereinafter, collectively referred to as “charts 600”), respectively, displayed in a graphic user interface of a client device accessing the system for optimizing digital advertising, according to some embodiments (e.g., client devices 110, and system for optimizing digital advertising 330-2). Charts 620 include a timeline representation of historical data, such as number of buyers for certain items, and enable a clear visualization of the user for the impact of an advertising campaign, timing offsets, and the like.

FIG. 6A includes a bar chart 610A illustrating a percentage breakup of consumers that are existing buyers 612-1, new to brand (only) 612-2, and new to brand and category 612-3 (hereinafter, collectively referred as “consumer types 612”). The total of 612-1, 612-2, and 612-3 adds up to a 100% (as every consumer is one of non-overlapping consumer types 612). Chart 620A illustrates a historical progression of each of consumer types 612 in curves 622-1, 622-2, and 622-3 (hereinafter, collectively referred to as “curves 622”), respectively.

FIG. 6B includes chart 620B for a certain consumer type. Screenshot 600B also includes a menu with multiple graphic features 650-1 (“new to brand”), 650-2 (“trial and repeat”), 650-3 (“by category”—or consumer type—), 650-4 (“attribution”), and 650-5 (“channel”), hereinafter, collectively referred to as “graphic features 650,” or ad creative 651 that the user may select.

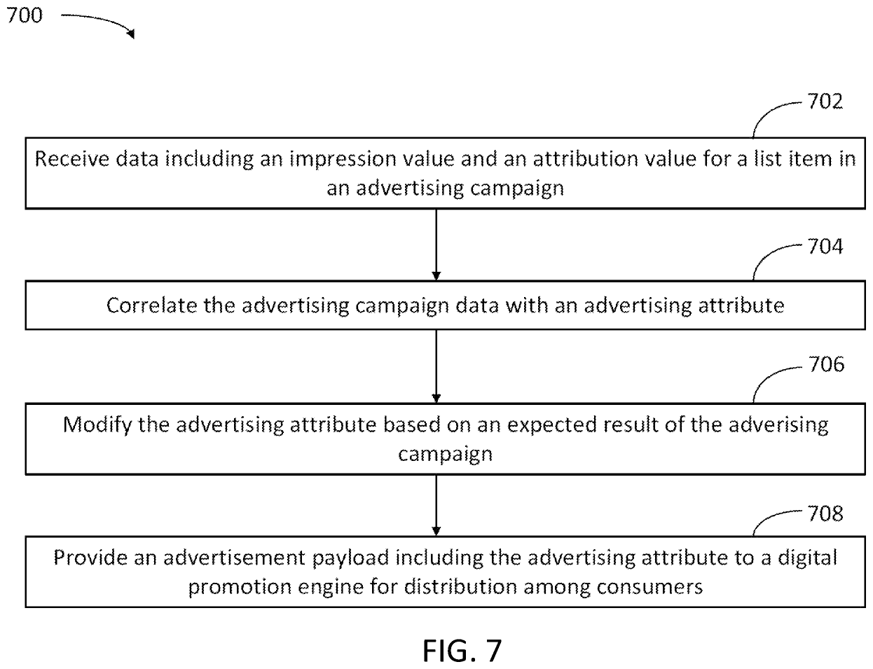

FIG. 7 is a flowchart illustrating steps in a method 700 for optimizing an advertising campaign, according to some embodiments. Method 700 may be performed at least partially by any one of the plurality of servers and client devices as disclosed herein (e.g., servers 130 and client devices 110). For example, at least some of the steps in method 700 may be performed by one component in a system, including a mobile device running code for an application hosted by a server (e.g., application 222). The server may include a multi-touch attribution engine running an algorithm in an impression to conversion tracking module (e.g., multi-touch attribution engine 242, algorithm 244, and impression to conversion tracking module 246). Accordingly, at least some of the steps in method 700 may be performed by a processor executing commands stored in a memory of the server, the mobile device, or a database accessible by the server or the mobile device (e.g., processors 212, memories 220, and databases 252). In some embodiments, at least one of the steps in method 700 may be performed by an advertising technology server and a system to optimize digital advertising campaigns (cf. advertising technology server 330-1 and system to optimize digital advertising 330-2). Further, in some embodiments, at least some of the steps in method 700 may be performed overlapping in time, almost simultaneously, or in a different order from the order illustrated in method 700. Moreover, a method consistent with some embodiments disclosed herein may include at least one, but not all, of the steps in method 700.

Step 702 includes receiving data including an impression value and an attribution value for a list item in an advertising campaign. In some embodiments, step 702 includes receiving data about the advertising campaign in an MTA attribution engine by an impression exposure to in-store purchase conversion tracking module. In some embodiments, step 702 includes receiving a pixel signal triggered when one or more users have accessed the advertisement payload. In some embodiments, step 702 includes correlating an impression datum provided by a client device with a consumer with an attribution datum provided by a point of sale device with a retailer. In some embodiments, step 702 includes determining a performance value of the advertising campaign as a ratio of the attribution value to the impression value for a selected advertisement channel. In some embodiments, a selected brand is an advertising campaign subject, and step 702 includes determining a performance value of the advertising campaign as a percentage of new consumers added to the selected brand relative to a total number of consumers of the selected brand. In some embodiments, a selected product category is an advertising campaign subject, and step 702 includes determining a performance value of the advertising campaign as a percentage of new consumers added to the selected product category relative to a total number of consumers of the selected product category.

Step 704 includes correlating the data with multiple advertising attributes of the advertising campaign to identify one or more salient attributes for an expected result of the advertising campaign. The advertising attribute may include a channel and a creative content. The channel may include a desktop channel, a mobile channel, or a mobile web application channel, and includes the different channels from which the system to optimize digital advertising campaigns will reach independent users or consumers during the advertising campaign. The creative content may include images, text, and short videos or image sequences associated with an item or service that is the subject of the advertising campaign. In some embodiments, step 704 includes extracting a semantic meaning of a textual content in the advertisement payload.

Step 706 includes modifying one or more salient attributes in an advertisement payload for the list item. In some embodiments, step 706 may include modifying a location for display of the advertisement. In some embodiments, step 706 includes changing an advertising channel of the advertisement payload for one or more users coupled to the network. In some embodiments, step 706 includes modifying one of a color, a format, a size, a theme, a shade, a gradation in a graphical element of the advertisement payload.

Step 708 includes providing the advertisement payload including the salient attribute to a server in a network for distribution among users communicatively coupled to the network. In some embodiments, the server in step 708 is a system to optimize digital advertising campaigns. In some embodiments, a system administrator may verify and qualify the resulting advertisement payload prior to providing to the advertising technology server. In some embodiments, one of the advertising attributes of the advertising campaign includes an advertising channel, and step 708 includes selecting the advertisement channel from a group consisting of a desktop, a mobile application, or a browser, based on a client device for one or more users communicatively coupled to the network.

Accordingly, embodiments as disclosed herein provide a home-built asset for a data-oriented service provider that is digitally independent from a network provider or device manufacturer. In some embodiments, the benefits of systems and methods as disclosed herein may be enhanced with partnerships with third party service providers, retailers, and brand manufacturers.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

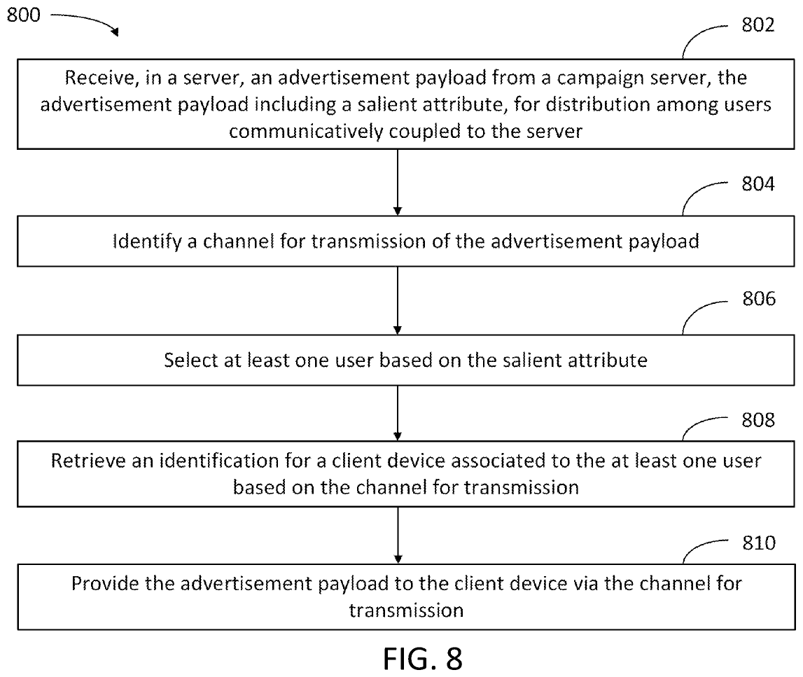

FIG. 8 is a flow chart illustrating steps in a method 800 for providing a personalized advertising payload to a client device, according to some embodiments. Method 800 may be performed at least partially by any one of the plurality of servers and client devices as disclosed herein (e.g., servers 130 and client devices 110). For example, at least some of the steps in method 800 may be performed by one component in a system, including a mobile device running code for an application hosted by a server (e.g., application 222). The server may include a multi-touch attribution engine running an algorithm in an impression to conversion tracking module (e.g., multi-touch attribution engine 242, algorithm 244, and impression to conversion tracking module 246). Accordingly, at least some of the steps in method 800 may be performed by a processor executing commands stored in a memory of the server, the mobile device, or a database accessible by the server or the mobile device (e.g., processors 212, memories 220, and databases 252). In some embodiments, at least one of the steps in method 800 may be performed by an advertising technology server and a system to optimize digital advertising campaigns (cf. advertising technology server 330-1 and system to optimize digital advertising 330-2). Further, in some embodiments, at least some of the steps in method 800 may be performed overlapping in time, almost simultaneously, or in a different order from the order illustrated in method 800.

Step 802 includes receiving, in a server, an advertisement payload from a campaign server, the advertisement payload including a salient attribute, for distribution among users communicatively coupled to the server.

Step 804 includes identifying a channel for transmission of the advertisement payload. In some embodiments, step 804 includes modifying the salient attribute in the advertisement payload by changing an advertising channel of the advertisement payload for one or more users coupled to the server. In some embodiments, step 804 includes modifying the salient attribute in the advertisement payload by modifying one of a color, a format, a size, a theme, a shade, a gradation in a graphical element of the advertisement payload.

Step 806 includes selecting at least one user based on the salient attribute.

Step 808 includes retrieving an identification for a client device associated to the at least one user based on the channel for transmission.

Step 810 includes providing the advertisement payload to the client device via the channel for transmission. In some embodiments, one of the advertising attributes of the advertising campaign includes an advertising channel, and step 810 includes selecting the advertisement channel from a group consisting of a desktop, a mobile application, or a browser, based on a client device for one or more users communicatively coupled to the server. In some embodiments, step 810 includes correlating data collected from multiple client devices for the users coupled to the server and from multiple point of sale devices in retailer stores with multiple advertising attributes includes extracting a semantic meaning of a textual content in the advertisement payload.

In some embodiments, the benefits of systems and methods as disclosed herein may be enhanced with partnerships with third party service providers, retailers, and brand manufacturers.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

### Hardware Overview

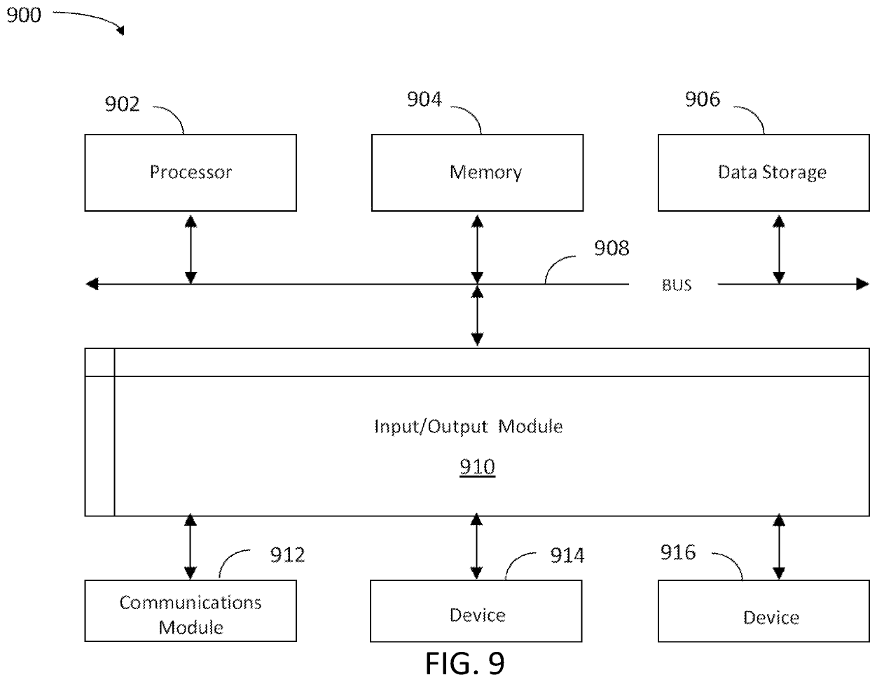

FIG. 9 is a block diagram illustrating an exemplary computer system 900 with which the client device 110 and server 130 of FIGS. 1 and 2, and the methods of FIGS. 7 and 8 can be implemented. In certain aspects, the computer system 900 may be implemented using hardware or a combination of software and hardware, either in a dedicated server, or integrated into another entity, or distributed across multiple entities.

Computer system 900 (e.g., client device 110 and server 130) includes a bus 908 or other communication mechanism for communicating information, and a processor 902 (e.g., processors 212) coupled with bus 908 for processing information. By way of example, the computer system 900 may be implemented with one or more processors 902. Processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 900 can include, in addition to hardware, code that creates an execution environment for the computer program in question, e.g., code that constitutes processor firmware, a protocol stack, a database management system, an operating system, or a combination of one or more of them stored in an included memory 904 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 908 for storing information and instructions to be executed by processor 902. The processor 902 and the memory 904 can be supplemented by, or incorporated in, special purpose logic circuitry.

The instructions may be stored in the memory 904 and implemented in one or more computer program products, e.g., one or more modules of computer program instructions encoded on a computer-readable medium for execution by, or to control the operation of, the computer system 900, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 904 may also be used for storing temporary variable or other intermediate information during execution of instructions to be executed by processor 902.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and inter-coupled by a communication network. The processes and logic flows described in this specification can be performed by one or more programmable processors executing one or more computer programs to perform functions by operating on input data and generating output.

Computer system 900 further includes a data storage device 906 such as a magnetic disk or optical disk, coupled with bus 908 for storing information and instructions. Computer system 900 may be coupled via input/output module 910 to various devices. Input/output module 910 can be any input/output module. Exemplary input/output modules 910 include data ports such as USB ports. The input/output module 910 is configured to connect to a communications module 912. Exemplary communications modules 912 (e.g., communications modules 218) include networking interface cards, such as Ethernet cards and modems. In certain aspects, input/output module 910 is configured to connect to a plurality of devices, such as an input device 914 (e.g., input device 214) and/or an output device 916 (e.g., output device 216). Exemplary input devices 914 include a keyboard and a pointing device, e.g., a mouse or a trackball, by which a consumer can provide input to the computer system 900. Other kinds of input devices 914 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 916 include display devices, such as an LCD (liquid crystal display) monitor, for displaying information to the consumer.

According to one aspect of the present disclosure, the client device 110 and server 130 can be implemented using a computer system 900 in response to processor 902 executing one or more sequences of one or more instructions contained in memory 904. Such instructions may be read into memory 904 from another machine-readable medium, such as data storage device 906. Execution of the sequences of instructions contained in main memory 904 causes processor 902 to perform the process steps described herein. One or more processors in a multi-processing arrangement may also be employed to execute the sequences of instructions contained in memory 904. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be inter-coupled by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 900 can include clients and servers. A client and server are generally remote from each other and typically interact through a communication network. The relationship of client and server arises by virtue of computer programs running on the respective computers and having a client-server relationship to each other. Computer system 900 can be, for example, and without limitation, a desktop computer, laptop computer, or tablet computer. Computer system 900 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 902 for execution. Such a medium may take many forms, including, but not limited to, non-volatile media, volatile media, and transmission media. Non-volatile media include, for example, optical or magnetic disks, such as data storage device 906. Volatile media include dynamic memory, such as memory 904. Transmission media include coaxial cables, copper wire, and fiber optics, including the wires forming bus 908. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

### RECITATION OF EMBODIMENTS

Embodiments as disclosed herein may include any one of the following:

Embodiment I: A computer-implemented method that includes receiving data including an impression value and an attribution value for a list item in an advertising campaign. The computer-implemented method also includes correlating the data with multiple advertising attributes of the advertising campaign to identify a salient attribute for an expected result of the advertising campaign, modifying the salient attribute in an advertisement payload for the list item, and providing the advertisement payload including the salient attribute to a server in a network for distribution among users communicatively coupled to the network.

Embodiment II: A system, includes one or more processors and a memory storing instructions which, when executed by the one or more processors, cause the system to perform operations. The operations include to receive data including an impression value and an attribution value for a list item in an advertising campaign, to correlate the data with multiple advertising attributes of the advertising campaign to identify a salient attribute for an expected result of the advertising campaign, to modify the salient attribute in an advertisement payload for the list item, and to provide the advertisement payload including the salient attribute to a server in a network for distribution among users communicatively coupled to the network, wherein modifying the salient attribute in the advertisement payload including changing an advertising channel of the advertisement payload for one or more users coupled to the network.

Embodiment III: A computer-implemented method, includes receiving, in a server, an advertisement payload from a campaign server, the advertisement payload including a salient attribute, for distribution among users communicatively coupled to the server. The computer-implemented method also includes identifying a channel for transmission of the advertisement payload, selecting at least one user based on the salient attribute, retrieving an identification for a client device associated to the at least one user based on the channel for transmission, and providing the advertisement payload to the client device via the channel for transmission.

Additionally, embodiments as disclosed herein may include any one of embodiments I, II, and III in combination with the following elements, taken in any permutation:

Element 1, wherein modifying the salient attribute in the advertisement payload including changing an advertising channel of the advertisement payload for one or more users coupled to the network. Element 2, wherein modifying the salient attribute in the advertisement payload includes modifying one of a color, a format, a size, a theme, a shade, a gradation in a graphical element of the advertisement payload. Element 3, wherein one of the advertising attributes of the advertising campaign includes an advertising channel, and providing the advertisement payload to a server includes selecting the advertisement channel from a group consisting of a desktop, a mobile application, or a browser, based on a client device for one or more users communicatively coupled to the network. Element 4, wherein correlating the data with multiple advertising attributes includes extracting a semantic meaning of a textual content in the advertisement payload. Element 5, wherein receiving data including an impression value and an attribution value for a list item in an advertising campaign includes receiving a pixel signal triggered when one or more users have accessed the advertisement payload. Element 6, wherein receiving data including an impression value and an attribution value for a list item in an advertising campaign includes correlating an impression datum provided by a client device with a consumer with an attribution datum provided by a point of sale device with a retailer. Element 7, further including determining a performance value of the advertising campaign as a ratio of the attribution value to the impression value for a selected advertisement channel. Element 8, wherein a selected brand is an advertising campaign subject, further including determining a performance value of the advertising campaign as a percentage of new consumers added to the selected brand relative to a total number of consumers of the selected brand. Element 9, wherein a selected product category is an advertising campaign subject, further including determining a performance value of the advertising campaign as a percentage of new consumers added to the selected product category relative to a total number of consumers of the selected product category.

Element 10, further including modifying the salient attribute in the advertisement payload by changing an advertising channel of the advertisement payload for one or more users coupled to the server. Element 11, further including modifying the salient attribute in the advertisement payload by modifying one of a color, a format, a size, a theme, a shade, a gradation in a graphical element of the advertisement payload. Element 12, wherein one of the advertising attributes of the advertising campaign includes an advertising channel, and providing the advertisement payload to a server includes selecting the advertisement channel from a group consisting of a desktop, a mobile application, or a browser, based on a client device for one or more users communicatively coupled to the server. Element 13, further including correlating data collected from multiple client devices for the users coupled to the server and from multiple point of sale devices in retailer stores with multiple advertising attributes includes extracting a semantic meaning of a textual content in the advertisement payload.

1. A computer-implemented method, comprising:
receiving data including an impression value and an attribution value for a list item in an advertising campaign;
correlating the data with multiple advertising attributes of the advertising campaign to identify a salient attribute for an expected result of the advertising campaign;
modifying the salient attribute in an advertisement payload for the list item; and
providing the advertisement payload including the salient attribute to a server in a network for distribution among users communicatively coupled to the network.

2. The computer-implemented method of claim 1, wherein modifying the salient attribute in the advertisement payload comprising changing an advertising channel of the advertisement payload for one or more users coupled to the network.

3. The computer-implemented method of claim 1, wherein modifying the salient attribute in the advertisement payload comprises modifying one of a color, a format, a size, a theme, a shade, a gradation in a graphical element of the advertisement payload.

4. The computer-implemented method of claim 1, wherein one of the advertising attributes of the advertising campaign comprises an advertising channel, and providing the advertisement payload to a server comprises selecting the advertisement channel from a group consisting of a desktop, a mobile application, or a browser, based on a client device for one or more users communicatively coupled to the network.

5. The computer-implemented method of claim 1, wherein correlating the data with multiple advertising attributes comprises extracting a semantic meaning of a textual content in the advertisement payload.

6. The computer-implemented method of claim 1, wherein receiving data including an impression value and an attribution value for a list item in an advertising campaign comprises receiving a pixel signal triggered when one or more users have accessed the advertisement payload.

7. The computer-implemented method of claim 1, wherein receiving data including an impression value and an attribution value for a list item in an advertising campaign comprises correlating an impression datum provided by a client device with a consumer with an attribution datum provided by a point of sale device with a retailer.

8. The computer-implemented method of claim 1, further comprising determining a performance value of the advertising campaign as a ratio of the attribution value to the impression value for a selected advertisement channel.

9. The computer-implemented method of claim 1, wherein a selected brand is an advertising campaign subject, further comprising determining a performance value of the advertising campaign as a percentage of new consumers added to the selected brand relative to a total number of consumers of the selected brand.

10. The computer-implemented method of claim 1, wherein a selected product category is an advertising campaign subject, further comprising determining a performance value of the advertising campaign as a percentage of new consumers added to the selected product category relative to a total number of consumers of the selected product category.

11. A system, comprising:
one or more processors; and
a memory storing instructions which, when executed by the one or more processors, cause the system to perform operations, comprising:
receive data including an impression value and an attribution value for a list item in an advertising campaign;
correlate the data with multiple advertising attributes of the advertising campaign to identify a salient attribute for an expected result of the advertising campaign;
modify the salient attribute in an advertisement payload for the list item; and
provide the advertisement payload including the salient attribute to a server in a network for distribution among users communicatively coupled to the network, wherein modifying the salient attribute in the advertisement payload comprising changing an advertising channel of the advertisement payload for one or more users coupled to the network.

12. The system of claim 11, wherein to modify the salient attribute in the advertisement payload the one or more processors execute instructions to modify one of a color, a format, a size, a theme, a shade, a gradation in a graphical element of the advertisement payload.

13. The system of claim 11, wherein one of the advertising attributes of the advertising campaign comprises an advertising channel, and to provide the advertisement payload to a server the one or more processors execute instructions to select the advertisement channel from a group consisting of a desktop, a mobile application, or a browser, based on a client device for one or more users communicatively coupled to the network.

14. The system of claim 11, wherein to correlate the data with multiple advertising attributes the one or more processors execute instructions to extract a semantic meaning of a textual content in the advertisement payload.

15. The system of claim 11, wherein to receive data including an impression value and an attribution value for a list item in an advertising campaign the one or more processors execute instructions to receive a pixel signal triggered when one or more users have accessed the advertisement payload.

16. A computer-implemented method, comprising:
receiving, in a server, an advertisement payload from a campaign server, the advertisement payload including a salient attribute, for distribution among users communicatively coupled to the server;
identifying a channel for transmission of the advertisement payload;
selecting at least one user based on the salient attribute;
retrieving an identification for a client device associated to the at least one user based on the channel for transmission; and
providing the advertisement payload to the client device via the channel for transmission.

17. The computer-implemented method of claim 16, further comprising modifying the salient attribute in the advertisement payload by changing an advertising channel of the advertisement payload for one or more users coupled to the server.

18. The computer-implemented method of claim 16, further comprising modifying the salient attribute in the advertisement payload by modifying one of a color, a format, a size, a theme, a shade, a gradation in a graphical element of the advertisement payload.

19. The computer-implemented method of claim 16, wherein an attribute of the advertisement payload comprises an advertising channel, and providing the advertisement payload to a server comprises selecting the advertisement channel from a group consisting of a desktop, a mobile application, or a browser, based on a client device for one or more users communicatively coupled to the server.

20. The computer-implemented method of claim 16, further comprising correlating data collected from multiple client devices for the at least one user coupled to the server and from multiple point of sale devices in retailer stores with multiple advertising attributes comprises extracting a semantic meaning of a textual content in the advertisement payload.
